(19) United States
(12) Patent Application Publication
(10) Pub. No.: US 2020/0401726 A1
(43) Pub. Date: Dec. 24, 2020

(54) SYSTEM AND METHOD FOR PRIVATE INTEGRATION OF DATASETS

(71) Applicant: Singapore Telecommunications Limited, Comcentre (SG)

(72) Inventors: Hoon Wei LIM, Comcentre (SG); Chittawar VARSHA, Comcentre (SG)

(73) Assignee: Singapore Telecommunications Limited, Comcentre (SG)

(21) Appl. No.: 16/764,983

(22) PCT Filed: Nov. 20, 2017
(86) PCT No.: PCT/SG2017/050575

§ 371 Date: May 18, 2020

(51) Int. Cl. G06F 21/62; H04L 9/08; H04L 9/06; H04L 9/32

(52) U.S. Cl. CPC G06F 21/6254; H04L 9/3221; H04L 9/0643; H04L 9/0822

(57) ABSTRACT

This document describes a system and method for sharing datasets between various modules or users whereby identity attributes in each dataset are obfuscated. The obfuscation is done such that when the separate datasets are combined, the identity attributes remain obfuscated while the remaining attributes in the combined datasets may be recovered by the users of the invention.

### FIELD OF THE INVENTION

This invention relates to a system and method for sharing datasets between various modules or users whereby identity attributes in each dataset are obfuscated. The obfuscation is done such that when the separate datasets are combined, the identity attributes remain obfuscated while the remaining attributes in the combined datasets may be recovered by the users of the invention.

In particular, each participant in the system is able to randomize their dataset via an independent and untrusted third party, such that the resulting dataset may be merged with other randomized datasets contributed by other participants in a privacy-preserving manner.

Moreover, the correctness of a randomized dataset returned by the third party may be securely verified by the participants.

### SUMMARY OF PRIOR ART

It is a known fact that various agencies or organizations independently collect data related to specific attributes of their users or customers, such as age, address, health status, occupation, salary, insured amounts, and etc. Each of these attributes would be associated to a particular user or customer using the user's unique identity attribute. A user's unique identity attribute may comprise the user's unique identifier such as their identity card number, their personal phone number, their birth certificate number, their home address or any means for uniquely identifying one user from the next.

Once these agencies have collected the required data, they tend to share the collected data with other organizations in order to improve the quality and efficiency of the services offered. In short, the sharing of datasets between agencies allows for the creation of a more complete dataset that has a larger number of attributes. However, for privacy reasons, it is of utmost importance that when the data is shared amongst the various agencies, the identities of the individual users should not be freely disclosed. This problem is typically known as the privacy-preserving data integration (PPDI) or data join problem.

Various solutions to address this problem have been proposed through the years however, the solutions proposed thus far have various limitations, ranging from the need for having a trusted third party, to requiring a secure hardware (processor) being used by each participant or by restricting the contributing organization from accessing a merged dataset (because doing so would allow re-identification of individuals in the dataset), to incurring prohibitive computational and communication overheads.

One of the solutions proposed by those skilled in the art involves the joining of two datasets from two parties whereby both parties exhibit “honest-but-curious” behaviours. This solution does not require a trusted third party however; this solution is not suitable for the sharing and integration of multiple datasets among a group of participants as this approach is not scalable beyond a limited number of participants.

Another solution proposed by those skilled in the art involves the implementation of a privacy-preserving schema and an approximate data matching solution. This approach involves the embedding of data records in a Euclidean space that provides some degree of privacy through random selections of the axes space. However, this solution requires a semi-trusted (or honest-but-curious) third party. An example of such privacy-preserving solutions designed specifically for peer-to-peer data management systems are the PeerDB and BestPeer solutions. The downside to these solutions is that they require semi-trusted intermediate nodes to integrate datasets between any two nodes.

Yet another solution proposed by those skilled in the art involves the building of a combinatorial circuit for performing secure and privacy-preserving computations. This circuit is then used to perform computations to find the intersection of two datasets while revealing only the computed intersection to users. The main downside to this approach is that multi-party computation typically requires substantial computational and communication overheads. Although there have been significant efficiency improvements over time on computation techniques for privacy-preserving set intersections (PPSI), generally, a solution that applies these techniques are still quite costly. Proposed PPSI protocols may seem efficient however, these protocols still have to be combined with a key sharing (based on coin tossing) protocol run among a group of participants. This is not ideal as key sharing among participants has its own set of limitations and problems.

A straightforward but somewhat naive approach to address the issue of privacy preservation in shared datasets requires all contributing participants to first share a common secret key through, for example, a secure group key exchange protocol, a secure data sharing protocol, or some out-of-band mechanism. Thereafter, the shared group key is used to deterministically randomize the target records in a database, e.g., ID column (NRIC), using HMAC. With that, any untrusted third party can merge randomized datasets submitted by multiple contributing participants with overwhelming accuracy. Moreover, such a solution is highly efficient and scalable. However, this approach introduces some serious security and privacy concerns. First, any contributing participant receiving a merged dataset (comprising attributes contributed by other participants) is able to correlate the identity information of all records with overwhelming probability. Second, all participants must trust that other participants will not reveal or share the common key with any other non-contributing or unauthorized participants. Finally, the leakage of the shared key via any of the participants will lead to exposure of the identity information of the entire dataset.

For the above reasons, those skilled in the art are constantly striving to come up with a system and method that is capable of supporting the sharing and integration of multiple datasets among a group of organizations through an untrusted third party without compromising the identities of individuals in the shared datasets. The solution should also enable verification of the correctness of privacy-preserved datasets without revealing any sensitive information to the untrusted third party and ideally, the private keys of the participants should not be required to be shared between all the participants.

### SUMMARY OF THE INVENTION

The above and other problems are solved and an advance in the art is made by systems and methods provided by embodiments in accordance with the invention.

A first advantage of embodiments of systems and methods in accordance with the invention is that an untrusted third party is used to play the role of a facilitator in consolidating individual datasets from different participants in a privacy-preserving manner. In operation, the third party and a participant jointly executes a protocol to anonymize the participant's dataset whereby the anonymized dataset may then be merged with other participants' datasets.

A second advantage of embodiments of systems and methods in accordance with the invention is the system and method is scalable and may accommodate any number of participants while efficiently preserving the privacy of identities associated with specific individuals in the datasets.

The above advantages are provided by embodiments of a method in accordance with the invention operating in the following manner.

According to a first aspect of the invention, a method for sharing datasets between modules whereby identity attributes in each dataset are encrypted is disclosed, the method comprising encrypting at a first module, identity attributes of the first module's dataset using a unique key k_{ed1} associated with the first module and an encryption function E( ) to produce an obfuscated dataset; receiving, by an untrusted server, the obfuscated dataset from the first module and further encrypting the encrypted identity attributes in the obfuscated dataset using a unique key kᵤₛ associated with the untrusted server and the encryption function E( ) to produce a further obfuscated dataset and shuffling the further obfuscated dataset; receiving, by an integration module, the further obfuscated and shuffled dataset from the untrusted server and receiving from the first module a unique key k_{dd1} associated with the first module, decrypting part of the encrypted identity attributes using the unique key k_{dd1} and a decryption function D( ), whereby the decryption function D( ) and the unique key k_{dd1} decrypts the encrypted identity attributes in the further obfuscated and shuffled dataset to produce a final first dataset having identity attributes that are only encrypted using the encryption function E( ) and the unique key kᵤₛ.

According to an embodiment of the first aspect of the disclosure, the method further comprises encrypting at a second module, identity attributes of the second module's dataset using a unique key k_{ed2} associated with the second module and the encryption function E( ) to produce a second obfuscated dataset; receiving, by the untrusted server, the second obfuscated dataset from the second module and further encrypting the encrypted identity attributes in the obfuscated dataset using the unique key kᵤₛ associated with the untrusted server and the encryption function E( ) to produce a second further obfuscated dataset and shuffling the second further obfuscated dataset; receiving, by the integrated module, the second further obfuscated and shuffled dataset from the untrusted server and receiving from the second module a unique key k_{dd2} associated with the second module, decrypting part of the encrypted identity attributes using the unique key k_{dd2} and the decryption function D( ), whereby the decryption function D( ) and the unique key k_{dd2} decrypts the encrypted identity attributes in the second further obfuscated and shuffled dataset to produce a final second dataset having identity attributes that are only encrypted using the encryption function E( ) and the unique key kᵤₛ, and combining, at the integrated module, the final first dataset with the final second dataset to produce an integrated dataset.

According to an embodiment of the first aspect of the disclosure, the encryption function E( ) is defined as Eₖ(ID)=H(ID)^{k} mod p where Eₖ is a commutative encryption function that operates in a group G, k is the unique key k_{ed1} associated with the first module, ID is an identity attribute, H is a cryptographic hash function that produces a random group element and p is (2q+1) where q is a prime number.

According to an embodiment of the first aspect of the disclosure, the decryption function D( ) is defined as the inverse of encryption function E( ) and the unique key k_{dd1} comprises an inverse of the unique key k_{ed1}.

According to an embodiment of the first aspect of the disclosure, the untrusted server further computes a zero-knowledge proof of correctness based on the encrypted identity attributes in the obfuscated dataset and the further encrypted identity attributes and forwards the zero-knowledge proof of correctness to the integration module, whereby the integration module decrypts part of the encrypted identity attributes using the unique key k_{dd1} and a decryption function D( ) if the received zero-knowledge proof of correctness matches with a zero-knowledge proof of correctness computed by the integration module.

According to an embodiment of the first aspect of the disclosure, the method further comprises encrypting, at the first module, non-identity type attributes of the first module's dataset using deterministic Advanced Encryption Standards.

According to a second aspect of the invention, a system for sharing datasets between modules whereby identity attributes in each dataset are encrypted is disclosed, a first module configured to encrypt identity attributes of the first module's dataset using a unique key k_{ed1} associated with the first module and an encryption function E( ) to produce an obfuscated dataset; a second module configured to receive the obfuscated dataset from the first module and further encrypt the encrypted identity attributes in the obfuscated dataset using a unique key kᵤₛ associated with the untrusted server and the encryption function E( ) to produce a further obfuscated dataset and shuffle the further obfuscated dataset; an integration module configured to: receive the further obfuscated and shuffled dataset from the untrusted server and receive from the first module a unique key k_{dd1} associated with the first module, decrypt part of the encrypted identity attributes using the unique key k_{dd1} and a decryption function D( ), whereby the decryption function D( ) and the unique key k_{dd1} decrypts the encrypted identity attributes in the further obfuscated and shuffled dataset to produce a final first dataset having identity attributes that are only encrypted using the encryption function E( ) and the unique key kᵤₛ.

According to an embodiment of the second aspect of the disclosure, the system further comprises a second module configured to encrypt identity attributes of the second module's dataset using a unique key k_{ed2} associated with the second module and the encryption function E( ) to produce a second obfuscated dataset; the untrusted server configured to receive the second obfuscated dataset from the second module and further encrypt the encrypted identity attributes in the obfuscated dataset using the unique key kᵤₛ associated with the untrusted server and the encryption function E( ) to produce a second further obfuscated dataset and shuffle the second further obfuscated dataset; the integrated module configured to: receive the second further obfuscated and shuffled dataset from the untrusted server and receive from the second module a unique key k_{dd2} associated with the second module, decrypt part of the encrypted identity attributes using the unique key k_{dd2} and the decryption function D( ), whereby the decryption function D( ) and the unique key k_{dd2} decrypts the encrypted identity attributes in the second further obfuscated and shuffled dataset to produce a final second dataset having identity attributes that are only encrypted using the encryption function E( ) and the unique key kᵤₛ, and combine the final first dataset with the final second dataset to produce an integrated dataset.

According to an embodiment of the second aspect of the disclosure, the encryption function E( ) is defined as Eₖ(ID)=H(ID)^{k} mod p where Eₖ is a commutative encryption function that operates in a group G, k is the unique key k_{ed1} associated with the first module, ID is an identity attribute, H is a cryptographic hash function that produces a random group element and p is (2q+1) where q is a prime number.

According to an embodiment of the second aspect of the disclosure, the decryption function D( ) is defined as the inverse of encryption function E( ) and the unique key k_{dd1} comprises an inverse of the unique key k_{ed1}.

According to an embodiment of the second aspect of the disclosure, the untrusted server is configured to: further compute a zero-knowledge proof of correctness based on the encrypted identity attributes in the obfuscated dataset and the further encrypted identity attributes, and forward the zero-knowledge proof of correctness to the integration module, whereby the integration module is configured to decrypt part of the encrypted identity attributes using the unique key k_{dd1} and a decryption function D( ) if the received zero-knowledge proof of correctness matches with a zero-knowledge proof of correctness computed by the integration module.

According to an embodiment of the second aspect of the disclosure, the first module is further configured to encrypt non-identity type attributes of the first module's dataset using deterministic Advanced Encryption Standards.

### BRIEF DESCRIPTION OF THE DRAWINGS

The above and other problems are solved by features and advantages of a system and method in accordance with the present invention described in the detailed description and shown in the following drawings.

FIG. 1 illustrating an exemplary dataset having general attributes that are each associated with an identity attribute in accordance with embodiments of the invention;

FIG. 2 illustrating a block diagram of a system for anonymizing identity attributes in participants' datasets using an untrusted third party and for sharing and merging the anonymized dataset with in accordance with embodiments of the invention;

FIG. 3 illustrating a block diagram representative of processing systems providing embodiments in accordance with embodiments of the invention;

FIG. 4 illustrating a flow diagram of a process for sharing and merging datasets between participants whereby identity attributes in each dataset are anonymized in accordance with embodiments of the invention.

### DETAILED DESCRIPTION

This invention relates to a system and method for sharing datasets between various modules, participants or users whereby identity attributes in each dataset are obfuscated. The obfuscation is done such that when the separate datasets are combined, the identity attributes remain obfuscated while the remaining attributes in the combined datasets may be subsequently recovered by the users of the invention prior to merging the datasets or after the datasets are merged.

In particular, each participant in the system is able to randomize their dataset via an independent and untrusted third party, such that the resulting dataset may be merged with other randomized datasets contributed by other participants in a privacy-preserving manner. Moreover, the correctness of a randomized dataset returned by the third party may be securely verified by the participants.

The system in accordance with embodiments of the invention is based on a privacy-preserving data integration protocol. The basic idea of the system is that through an interactive protocol between a participant of the system and a centralized untrusted third party, each contributing participant will first randomize its dataset with a distinct secret value that is not known or shared with any other participants of the system. The randomized dataset is then submitted to an untrusted third party, which further randomizes the dataset using a unique secret value known to only the untrusted third party. The resulting dataset is then provided to another participant (may include the original participant) such that it can be merged with another randomized dataset from another participant without revealing any of the identity attributes in the dataset.

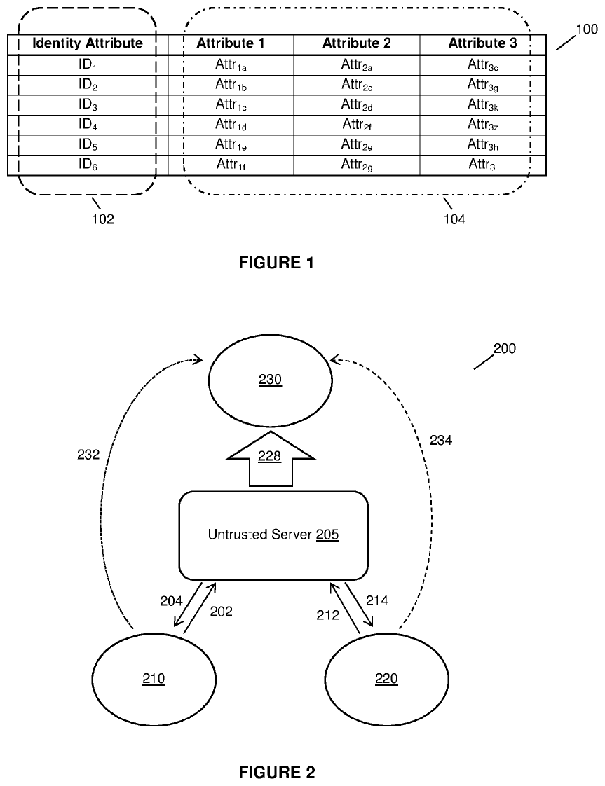

The system functions as follows. A participant first performs generalization and randomization processes on its dataset. An exemplary dataset is illustrated in FIG. 1 whereby dataset 100 is illustrated to have a column for identity attributes 102 and multiple columns for other general attributes 104. One skilled in the art will recognize that dataset 100 may comprise of any rows or columns of general attributes 104 and any number of rows of identity attribute 102 without departing from this invention. Dataset 100 may also be arranged in various other configurations without departing from the invention. Further, identity attribute 102 may refer to any unique identifier that may be used to identity a unique user while general attribute 104 may refer to any attribute that may be associated with a unique user.

During the generalization process, standard anonymization techniques will be applied to general attributes 104, i.e. the non-identity attributes, such as age, salary, postcode, etc. The objective of these standard anonymization techniques is to obfuscate the unique values in the non-identity attribute columns. As for the randomization process that is applied to identity attributes 102, the identity attributes 102 are scrambled using specific cryptographic techniques that will be described in greater detail in subsequent sections.

The generalized and randomized dataset is then forwarded by the participant to an untrusted third party server for further processing. At the untrusted third party server, the server then applies a specific blinding technique on randomized identity attributes 102 so that the participant will no longer be able to correlate identities from the randomized identity attributes 102 with the original identity attributes 102 (before randomization). Furthermore, the server will also randomly shuffle the dataset to minimize information leakage through the correlation of the general attributes 104. As the dataset has been randomized beforehand by the participant, the untrusted third party server will not be able to glean any information about the original dataset, except for the size of the dataset and possibly any minimal information leakage about the patterns of the dataset (the amount of leakage depends upon specific cryptographic algorithms chosen for randomization). The server also generates a proof of correctness such that it can be verified by the original participant that the blinding operation over the randomized dataset has been performed as expected.

Upon receiving the processed dataset from the untrusted third party server, the participant which produced the randomized and anonymized dataset will then verify the received proof of correctness and may then merge its blinded dataset with other datasets (also processed by the same server) obtained from other participants. The integration of the private datasets is done by the participant itself without any interactions with the server. Once this is done, the participant will be in possession of the final merged dataset. The approach above ensures that although the participant is able to merge its dataset with other datasets, a participant of the system will be unable to correlate a blinded identity attribute column with the associated original identity attribute column. Similarly, the server is also not able to re-identify any specific individuals from the merged datasets.

FIG. 2 illustrates a network diagram of a system for anonymizing identity attributes in participants' datasets using an untrusted third party and for sharing and merging the anonymized dataset with in accordance with embodiments of the invention. System 200 comprises modules 210, 220, and 230 which are the participants of the system and untrusted server 205. It should be noted that module 210, 220 and 230 may be contained within a single computing device, multiple computing devices or any other combinations thereof.

Further, a computing device may comprise of a tablet computer, a mobile computing device, a personal computer, or any electronic device that has a processor for executing instructions stored in a non-transitory memory. As for untrusted server 205, this server may comprise a cloud server or any other types of servers that may be located remote from or adjacent to modules 210, 220 and 230. Server 205 and modules 210, 220 and 230 may be communicatively connected through conventional wireless or wired means and the choice of connection is left as a design choice to one skilled in the art.

Module 210 will first generate a unique encryption key k_{ed1} that is unique and known to only module 210. This key is then used together with an encryption function E(k_{ed1},ID₁₀₂) to encrypt the identity attributes in a dataset. For example, under the assumption that dataset 100 (as shown in FIG. 1) is to be obfuscated and shared in accordance with embodiments of the invention, identity attributes 102 will be first encrypted using the encryption function E(k_{ed1},ID₁₀₂). General attributes 104 may also be obfuscated using standard encryption algorithms such as Advanced Encryption Standards-128 (AES-128).

The obfuscated dataset is then sent from module 210 to untrusted server 205 at step 202. Upon receiving the obfuscated dataset, server 205 will then further encrypt the encrypted identity attributes in the obfuscated dataset using a unique key kᵤₛ that is known only to server 205 and the similar encryption function E( ) to produce a further obfuscated dataset. The encryption function used by server 205 may be described by E(kᵤₛ,E(k_{ed1},ID₁₀₂)). The further obfuscated dataset may then be shuffled by server 205.

At this stage, the further obfuscated dataset may be forwarded back to module 210 at step 204 or may be forwarded onto module 230 at step 228. The further obfuscated dataset may be forwarded to either module or any combinations of modules at this stage. The only requirement is that the receiving module needs to have the required decryption key that is to be used with a decryption function to decrypt the encryption function E(k_{ed1}, ID₁₀₂).

In the embodiment whereby the further obfuscated dataset is forwarded to module 210 at step 204, it is assumed that module 210 is in possession of the unique decryption key k_{dd1} and the decryption function D( ). Hence, when these two parameters are applied to the further obfuscated dataset as received from server 205, this results in D(k_{dd1},E(kᵤₛ,E(k_{ed1},ID₁₀₂))).

It is useful to note at this stage that the encryption function E( ) employed by module 210, the encryption function E( ) employed by server 205 and decryption function D( ) employed by module 210 all comprise oblivious pseudorandom functions that are constructed based on commutative encryption protocols. Hence, after the decryption function D(k_{dd1},E(kᵤₛ,E(k_{ed1},ID₁₀₂))) has been applied, the result obtained at module 210 is E(kᵤₛ,ID₁₀₂). At this stage, it can be seen that module 210 is in possession of a dataset that has its identity attributes obfuscated by server 205. Hence, module 210 is actually unaware of the identities in the identity attribute column as these attributes have been encrypted using a key known to only untrusted server 205.

In the embodiment whereby the further obfuscated dataset is forwarded to module 230 at step 228, it is assumed that module 210 would have forwarded its unique decryption key k_{dd1} to module 230 and that the decryption function D( ) is already known to module 230. Hence, at module 230, when these two parameters are applied to the further obfuscated dataset as received from server 205, this results in the similar function, D(k_{dd1}, E(kᵤₛ,E(k_{ed1},ID₁₀₂))) where the result obtained is E(kᵤₛ,ID₁₀₂). One skilled in the art will recognize that modules 210 and 230 may be provided in a single device, two separate devices or within any combination of devices without departing from this invention.

As for module 220, module 220 will similarly first generate its own unique encryption key k_{ed2}. This key is then used together with the encryption function E( ), e.g. E(k_{ed2},ID₂₂₀), to encrypt the identity attributes in its dataset. Similarly, general attributes in its dataset may also be obfuscated using standard encryption algorithms.

The obfuscated dataset is then sent from module 220 to untrusted server 205 at step 212. Upon receiving the obfuscated dataset, server 205 will then further encrypt the encrypted identity attributes in the obfuscated dataset using the unique key kᵤₛ that is known only to server 205 and the encryption function E( ) to produce a further obfuscated dataset. The encryption function used by server 205 may be described by E(kᵤₛ,E(k_{ed2},ID₂₂₀)). The further obfuscated dataset may then be shuffled by server 205.

At this stage, the further obfuscated dataset may be forwarded back to module 220 at step 214 or may be forwarded onto module 230 at step 228. As mentioned above, the further obfuscated dataset may be forwarded to either module or any combinations of modules at this stage. The only requirement is that the receiving module needs to have the required decryption key that is to be used with a decryption function to decrypt the encryption function E(k_{ed2}, ID₂₂₀).

In the embodiment whereby the further obfuscated dataset is forwarded to module 220 at step 214, it is assumed that module 220 is in possession of the unique decryption key k_{dd2} and the decryption function D( ). Hence, when these two parameters are applied to the further obfuscated dataset as received from server 205, this results in D(k_{dd2},E(kᵤₛ,E(k_{ed2},ID₂₂₀))).

Hence, after the decryption function D(k_{dd2},E(kᵤₛ,E(k_{ed2},ID₂₂₀))) has been applied, the result obtained at module 220 is E(kᵤₛ,ID₂₂₀). At this stage, it can be seen that module 220 is in possession of a dataset that has its identity attributes obfuscated by server 205.

In the embodiment whereby the further obfuscated dataset is forwarded to module 230 at step 228, it is assumed that module 220 would have forwarded its unique decryption key k_{dd2} to module 230 at step 234 and that the decryption function D( ) is already known to module 230. Hence, at module 230, when these two parameters are applied to the further obfuscated dataset as received from server 205, this results in the similar function, D(k_{dd2},E(kᵤₛ,E(k_{ed2},ID₂₂₀))) where the result obtained is E(kᵤₛ,ID₂₂₀). One skilled in the art will recognize that modules 220 and 230 may be provided in a single device, two separate devices or within any combination of devices without departing from this invention.

### Exemplary Embodiment

The following example is used as an exemplary embodiment to describe the invention. This embodiment utilizes generic cryptographic primitives and the notation used in the protocol is described in Table 1 below. In this example, each record in the dataset that is to be obfuscated is assumed to be in the format of a tuple, e.g. (ID, Att) where “ID” represents an identity attribute and “Att” represents a general attribute.

TABLE 1

| | |
|---|---|
| C | Client |
| S | Server |
| C → S | Data transmission from C to S |
| IDᵢ | Identity record of i in a dataset |
| Attᵢ | Attribute value of record I in a dataset |
| Encₖ( ) | Deterministic encrypt algorithm with key k |
| Decₖ( ) | Deterministic decrypt algorithm |
| | (corresponding to Enc) with key k |
| Fₖ( ) | Commutative encrypt algorithm with key k |
| Fₖ⁻¹( ) | The inverse of F such that Fₖ⁻¹ = Fₖ_{^{−1}}( ) |
| H( ) | Cryptographic hash function |
| P( ) | Random permutation function |
| username | Client's username for |
| | accessing the protocol |

The following sections set out the various steps to obfuscate the identity attributes in a given dataset. It should be noted that the notations in Table 1 are used in the following section.

### 1. Key Setup

(1a) C generates a key x associated with F; and sets k=H(x; username) to be a key associated with the encryption function Enc( ).
(1b). S generates a key y associated with F.

### 2. Generalization and Randomization

(2a) C first performs generalization on its dataset (the attribute column).
(2b) C then performs randomization on each record (ID, Att) of its dataset:
   {for each IDᵢ, compute αᵢ=Fₓ(IDᵢ);
   {for each Attᵢ, compute τᵢ=Encₖ(Attᵢ)
(2c) C submits to S the randomized dataset (αᵢ, τᵢ); for all iϵ[1; n] where n represents the number of records in the dataset.

### 3. Blinding and Permutation

(3a) S blinds each received αᵢ by computing βᵢ=F_{y}(αᵢ)
(3b) S also shuffles the dataset by setting
   [(βⱼ₁, αⱼ₁), . . . ,(βⱼₙ, αⱼₙ)]=P[(β₁, α₁), . . . ,(βₙ, αₙ)]
(3c) S computes a zero-knowledge proof π of correctness from all (αⱼᵢ, βⱼᵢ) elements.
(3d) S returns [(βⱼ₁, αⱼ₁) . . . (βⱼₙ, αⱼₙ), −π] to C.

### 4. Verification and Integration

(4a) C verifies zero-knowledge proof π of correctness.
(4b) If zero-knowledge proof π of correctness is valid, C performs the following (otherwise C aborts):
   for each βⱼᵢ in the blinded dataset (where jᵢϵ[1; n]), extract δⱼᵢ=Fₓ⁻¹(βⱼᵢ)=F_{y}(IDⱼᵢ);
   for each τⱼᵢ, compute Decₖ(τⱼᵢ) to recover the generalized attribute column.
(4c) Given two datasets D₁=[(δⱼ₁; Attⱼ₁) . . . (δⱼₙ; Attᵢₙ)] and D₂=[(δ′ⱼ₁; Att′ⱼ₁) . . . (δ′ⱼₙ; Att′ⱼₙ)], perform a join operation to produce a single integrated dataset such that:
   if δᵢϵ_{D1}=δ′ⱼϵD₂ for some iϵ[1, n] and jϵ[1, n′], record (δᵢ, Attᵢ) will be merged with record (δⱼ, Att′ⱼ) to become (δᵢ, Attᵢ, Att′ⱼ);
   if δᵢϵD₁ does not match any δ′ⱼϵD₂ for any jϵ[1, n′], the record is generated as (δᵢ, Attᵢ, NULL);
   if any remaining records in D₂ containing δ′ⱼ without a match (with any record in D₁), the record is output as (δ′ⱼ, NULL, Att′ⱼ).
      The generalization techniques that are applied to the non-identity attributes refer to standard anonymization techniques for removing unique values or identifiers from these non-identity attributes. As for the commutative encrypt function with key k, Fₓ( ), this function comprises an oblivious pseudorandom function, which can be instantiated using a commutative encryption scheme. The commutative encrypt function F( ) may be one that operates in a group G, such that the Decisional Diffie-Hellman (DDH) problem is hard. For example, a subgroup of size q of all quadratic residues of a cyclic group with order p may be employed, where p is a strong prime, that is, p=2q+1 with q prime. The commutative encryption function can then be defined as:

Fⱼ(ID)=H(ID)^{k} mod p

where H:{0, 1}*→{1, 2 . . . q−1} produces a random group element. Here, the powers commute such that:

(H(ID)^{k}^{₁} mod p)^{k}^{₂} mod p=H(ID)^{k}^{₁}^{k}^{₂} mod p=(H(ID)^{k}^{₂} mod p)^{k}^{₁} mod p

This implies that each of the powers Fₖ is a bijection with its inverse being:

Fₖ⁻¹=Fₖ_{^{−1}}_{mod q}

We note that F is deterministic, and thus cannot be semantically secure; however, this is a property required for this PPDI solution. On the other hand, the Enc( ) and Dec( ) algorithms can be instantiated by standard AES-128; while the H( ) function can be performed by standard SHA-256. To instantiate P, one can apply AES to the index i of each element of a target set S and use the first log(|S|) bits of the output as the random (permuted) index j corresponding to i.
In summary, if Fₖ(ID)=H(ID)^{k} is the commutative encryption function, this implies that Fₖ( )⁻¹ is the corresponding decryption function. For a cyclic group, a corresponding decryption function would be Fₖ_{^{−1}} where k⁻¹ is the inverse of k within the group and may be regarded as the decryption key in this function.

### Zero-Knowledge Proof π of Correctness

At step (3c) above, the server is aware of αᵢ=Fₓ(IDᵢ) and βᵢ=F_{y}(αᵢ)=F_{xy}(IDᵢ) for all i in a submitted dataset. On the other hand, at step (4a) above, the client will be aware of all elements αᵢ and βᵢ as well. A zero-knowledge proof of correctness may then be carried out based on these information.
Using the zero-knowledge proof protocol, the server can prove to the client of its knowledge of the key y (that was used for blinding) without revealing y to the client. This can be explained as follows. In step (1) of the zero-proof protocol, the server computes:

$$V = {U}^{y} = {( {\prod }_{i = 1}^{n} {α}_{i} )}^{y} = {( {\prod }_{i = 1}^{n} {F}_{x} ( {ID}_{i} ) )}^{y} = {\prod }_{i = 1}^{n} {F}_{x y} ( {ID}_{i} )$$

The server then picks a random element s from {1, 2 . . . q−1} and computes T=U^{s}. c is set as c=H(U, V, T) and t=s−c·y. The proof is then produced by the server as πc=(c, t).
As the client is aware of V and U, the client is able to verify that all αᵢ elements have been correctly blinded with y by computing U′=Πᵢ₌₁ⁿαᵢ and V′=Πᵢ₌₁ⁿβᵢ. Then, the following is obtained by the client T′=(U′)^{t}·(V′)^{c} and c′=H(U′, V′, T′). A “TRUE” output is then generated if c′=c.
It is interesting to note that the client computes U′ based on the αᵢ elements that it initially computed before sending them to the server, while V′ is computed based on the βᵢ values received from the server. If the server had properly executed the agreed upon protocol, the client will be able to obtain T′=T because

T′=(U′)^{t}·(V′)^{c}=(U′)^{s-c·y}·(U^{y})^{c}=U^{s}=T

Where U′=U and V=V. Hence, if any intentional or unintentional modifications were to be made to any element αᵢ by the server, this would produce an incorrect proof that will be detected by the client.

The protocol described above accords full-privacy to all identity information contained within a dataset. From each client's perspective, each blinded ID record is cryptographically indistinguishable from any other blinded ID in a dataset. In other words, it would be computationally infeasible for the client to re-identify a specific ID record by correlating its original dataset with a merged dataset incorporating attributes contributed by other clients. This condition is met if all other non-identity attributes in the merged dataset also have sufficient level of privacy protection that minimizes a statistical inference attack. Hence for the sake of completeness, the protocol incorporates basic data generation techniques to minimize the risk of re-identification of an individual while ensuring reasonably high-utility of a generalized dataset. This can be enhanced further by other independent privacy preservation techniques.

From the server's viewpoint, all it does is to process (i.e., blind and permute) randomized datasets submitted by clients. That is, all files submitted by the clients and their corresponding processed files are cryptographically protected. Moreover, the correctness of processed files by the server is verifiable by the client.

The proposed privacy-preservation approach enables multiple datasets to be merged with full data linkage accuracy. As the focus is on protecting the ID column of a dataset and as it was assumed that each identifier is unique for each individual, the proposed solution provides guarantee of perfect linkage accuracy between two datasets. This is because each blinded ID will always be guaranteed to be randomly and deterministically mapped to a unique point on an elliptic curve over a group of order 239 bits. Therefore, the same ID submitted through two different datasets by different clients would always end up with the same random-looking blinded ID string. This, in turn, enables privacy-preserving dataset integration based on the ID column.

A basic k-anonymization technique was utilized for generalizing a dataset, i.e., by grouping each attribute value into more general classes. This ensures support for a reasonably high-level of data utility, including standard statistical analysis, such as mean, mode, minimum, maximum, and so on. There exists a range of other noise-based perturbation and data sanitization techniques which may be adopted to complement our ID blinding technique with different utility vs. privacy trade-offs. The utility level of a privacy-preserved dataset through this approach depends on specific use cases and application scenarios. Typically, specific knowledge (that about a small group of individuals) has a larger impact on privacy, while aggregate information (that about a large group of individuals) has a larger impact on utility. Moreover, privacy is an individual concept and should be measured separately for every individual while utility is an aggregate concept and should be measured accumulatively for all useful knowledge. Hence, measuring the trade-off between utility and privacy itself could be very involved and complex.

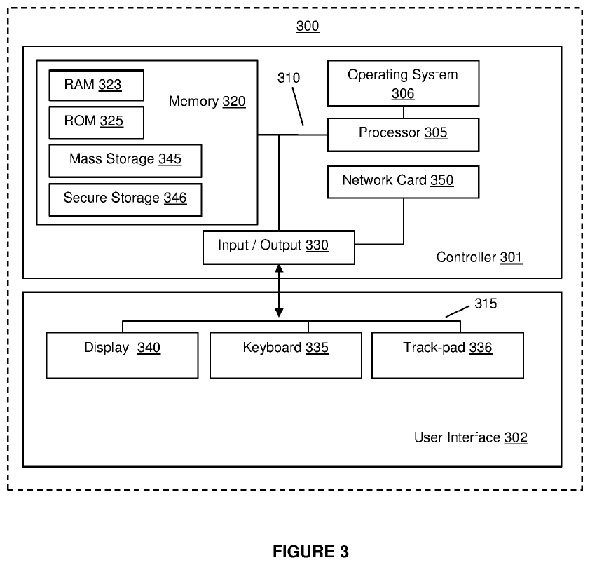

FIG. 3 illustrates a block diagram representative of components of processing system 300 that may be provided within modules 210, 220, 230 and server 205 for implementing embodiments in accordance with embodiments of the invention. One skilled in the art will recognize that the exact configuration of each processing system provided within these modules and servers may be different and the exact configuration of processing system 300 may vary and FIG. 3 is provided by way of example only.

In embodiments of the invention, module 300 comprises controller 301 and user interface 302. User interface 302 is arranged to enable manual interactions between a user and module 300 and for this purpose includes the input/output components required for the user to enter instructions to control module 300. A person skilled in the art will recognize that components of user interface 302 may vary from embodiment to embodiment but will typically include one or more of display 340, keyboard 335 and track-pad 336.

Controller 301 is in data communication with user interface 302 via bus 315 and includes memory 320, processor 305 mounted on a circuit board that processes instructions and data for performing the method of this embodiment, an operating system 306, an input/output (I/O) interface 330 for communicating with user interface 302 and a communications interface, in this embodiment in the form of a network card 350. Network card 350 may, for example, be utilized to send data from electronic device 300 via a wired or wireless network to other processing devices or to receive data via the wired or wireless network. Wireless networks that may be utilized by network card 350 include, but are not limited to, Wireless-Fidelity (Wi-Fi), Bluetooth, Near Field Communication (NFC), cellular networks, satellite networks, telecommunication networks, Wide Area Networks (WAN) and etc.

Memory 320 and operating system 306 are in data communication with CPU 305 via bus 310. The memory components include both volatile and non-volatile memory and more than one of each type of memory, including Random Access Memory (RAM) 320, Read Only Memory (ROM) 325 and a mass storage device 345, the last comprising one or more solid-state drives (SSDs). Memory 320 also includes secure storage 346 for securely storing secret keys, or private keys. It should be noted that the contents within secure storage 346 are only accessible by a super-user or administrator of module 300 and may not be accessed by any user of module 300. One skilled in the art will recognize that the memory components described above comprise non-transitory computer-readable media and shall be taken to comprise all computer-readable media except for a transitory, propagating signal. Typically, the instructions are stored as program code in the memory components but can also be hardwired. Memory 320 may include a kernel and/or programming modules such as a software application that may be stored in either volatile or non-volatile memory.

Herein the term “processor” is used to refer generically to any device or component that can process such instructions and may include: a microprocessor, microcontroller, programmable logic device or other computational device. That is, processor 305 may be provided by any suitable logic circuitry for receiving inputs, processing them in accordance with instructions stored in memory and generating outputs (for example to the memory components or on display 340). In this embodiment, processor 305 may be a single core or multi-core processor with memory addressable space. In one example, processor 305 may be multi-core, comprising—for example—an 8 core CPU.

In accordance with embodiments of the invention, a method for sharing datasets between modules whereby identity attributes in each dataset are encrypted comprises the following steps:
Step 1, encrypting at a first module, identity attributes of the first module's dataset using a unique encryption key k_{ed1} associated with the first module and an encryption function E( );
Step 2, receiving, by an untrusted server, the obfuscated dataset from the first module and further encrypting the encrypted identity attributes in the obfuscated dataset using a unique key kᵤₛ associated with the untrusted server and an encryption function Eᵤₛ( ) to produce a further obfuscated dataset and shuffling the further obfuscated dataset;
Step 3, receiving, by a second module, the further obfuscated and shuffled dataset from the untrusted server and receiving from the first module a unique decryption key k_{dd1} associated with the first module, and decrypting part of the encrypted identity attributes using the unique decryption key k_{dd1} and a decryption function D( ),
   wherein the decryption function D( ) reverses the encryption E( ) as applied to the further obfuscated and shuffled dataset to produce a final first dataset that is encrypted by the encryption function Eᵤₛ( ).

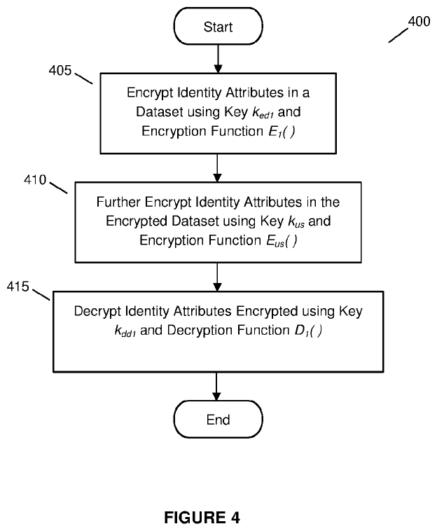

In embodiments of the invention, a process is needed for quantitatively unifying and analysing unstructured threat intelligence data from a plurality of upstream sources. The following description and FIG. 4 describes embodiments of processes in accordance with this invention.

FIG. 4 illustrates process 400 that is performed by a module and a server in a system to share datasets between modules in accordance with embodiments of this invention. Process 400 begins at step 405 with a participant module encrypting identity attributes in its dataset using its own private encryption key. The obfuscated dataset is then forwarded to an untrusted third party server to be further encrypted. At step 410, the server then further encrypts the identity attributes in the obfuscated dataset using its own private key and its encryption function. The further obfuscated dataset is then forwarded to a module that has the relevant decryption key. At step 415, the module receiving the further obfuscated dataset then utilizes the decryption key to decrypt the further obfuscated dataset such that the obfuscated dataset only comprises identity attributes that are encrypted using the server's private encryption key. Process 400 then ends.

Steps 405-415 may be repeated by other modules for their respective datasets. The final obfuscated datasets may then be combined in any module to produce a unified integrated dataset whereby the identities of users in the datasets are all protected and private.

The above is a description of embodiments of a system and process in accordance with the present invention as set forth in the following claims. It is envisioned that others may and will design alternatives that fall within the scope of the following claims.

1. A method for sharing datasets between modules whereby identity attributes in each dataset are encrypted, the method comprising:
encrypting at a first module, identity attributes of the first module's dataset using a unique key k_{ed1} associated with the first module and an encryption function E( ) to produce an obfuscated dataset;
receiving, by an untrusted server, the obfuscated dataset from the first module and further encrypting the encrypted identity attributes in the obfuscated dataset using a unique key kᵤₛ associated with the untrusted server and the encryption function E( ) to produce a further obfuscated dataset and shuffling the further obfuscated dataset;
receiving, by an integration module, the further obfuscated and shuffled dataset from the untrusted server and receiving from the first module a unique key k_{dd1} associated with the first module, decrypting part of the encrypted identity attributes using the unique key k_{dd1} and a decryption function D( ),
whereby the decryption function D( ) and the unique key k_{dd1} decrypts the encrypted identity attributes in the further obfuscated and shuffled dataset to produce a final first dataset having identity attributes that are only encrypted using the encryption function E( ) and the unique key kᵤₛ.

2. The method according to claim 1 further comprising:
encrypting at a second module, identity attributes of the second module's dataset using a unique key k_{ed2} associated with the second module and the encryption function E( ) to produce a second obfuscated dataset;
receiving, by the untrusted server, the second obfuscated dataset from the second module and further encrypting the encrypted identity attributes in the obfuscated dataset using the unique key kᵤₛ associated with the untrusted server and the encryption function E( ) to produce a second further obfuscated dataset and shuffling the second further obfuscated dataset;
receiving, by the integrated module, the second further obfuscated and shuffled dataset from the untrusted server and receiving from the second module a unique key k_{dd2} associated with the second module, decrypting part of the encrypted identity attributes using the unique key k_{dd2} and the decryption function D( ),
whereby the decryption function D( ) and the unique key k_{dd2} decrypts the encrypted identity attributes in the second further obfuscated and shuffled dataset to produce a final second dataset having identity attributes that are only encrypted using the encryption function E( ) and the unique key kᵤₛ, and
combining, at the integrated module, the final first dataset with the final second dataset to produce an integrated dataset.

3. The method according to claim 1 wherein the encryption function E( ) is defined as
Eₖ(ID)=H(ID)^{k} mod p
where Eₖ is a commutative encryption function that operates in a group G, k is the unique key k_{ed1} associated with the first module, ID is an identity attribute, H is a cryptographic hash function that produces a random group element and p is (2q+1) where q is a prime number.

4. The method according to claim 3 wherein the decryption function D( ) is defined as the inverse of encryption function E( ) and the unique key k_{dd1} comprises an inverse of the unique key k_{ed1}.

5. The method according to claim 1 wherein the untrusted server further computes a zero-knowledge proof of correctness based on the encrypted identity attributes in the obfuscated dataset and the further encrypted identity attributes and forwards the zero-knowledge proof of correctness to the integration module, whereby the integration module decrypts part of the encrypted identity attributes using the unique key k_{dd1} and a decryption function D( ) if the received zero-knowledge proof of correctness matches with a zero-knowledge proof of correctness computed by the integration module.

6. The method according to claim 1 further comprising encrypting, at the first module, non-identity type attributes of the first module's dataset using deterministic Advanced Encryption Standards.

7. A system for sharing datasets between modules whereby identity attributes in each dataset are encrypted, the system comprising:
a first module configured to encrypt identity attributes of the first module's dataset using a unique key k_{ed1} associated with the first module and an encryption function E( ) to produce an obfuscated dataset;
a second module configured to receive the obfuscated dataset from the first module and further encrypt the encrypted identity attributes in the obfuscated dataset using a unique key kᵤₛ associated with the untrusted server and the encryption function E( ) to produce a further obfuscated dataset and shuffle the further obfuscated dataset;
an integration module configured to:
receive the further obfuscated and shuffled dataset from the untrusted server and receive from the first module a unique key k_{dd1} associated with the first module,
decrypt part of the encrypted identity attributes using the unique key k_{dd1} and a decryption function D( ),
whereby the decryption function D( ) and the unique key k_{dd1} decrypts the encrypted identity attributes in the further obfuscated and shuffled dataset to produce a final first dataset having identity attributes that are only encrypted using the encryption function E( ) and the unique key kᵤₛ.

8. The system according to claim 7 further comprising:
a second module configured to encrypt identity attributes of the second module's dataset using a unique key k_{ed2} associated with the second module and the encryption function E( ) to produce a second obfuscated dataset;
the untrusted server configured to receive the second obfuscated dataset from the second module and further encrypt the encrypted identity attributes in the obfuscated dataset using the unique key kᵤₛ associated with the untrusted server and the encryption function E( ) to produce a second further obfuscated dataset and shuffle the second further obfuscated dataset;
the integrated module configured to:
receive the second further obfuscated and shuffled dataset from the untrusted server and receive from the second module a unique key k_{dd2} associated with the second module,
decrypt part of the encrypted identity attributes using the unique key k_{dd2} and the decryption function D( ),
whereby the decryption function D( ) and the unique key k_{dd2} decrypts the encrypted identity attributes in the second further obfuscated and shuffled dataset to produce a final second dataset having identity attributes that are only encrypted using the encryption function E( ) and the unique key kᵤₛ, and
combine the final first dataset with the final second dataset to produce an integrated dataset.

9. The system according to claim 7 wherein the encryption function E( ) is defined as
Eₖ(ID)=H(ID)^{k} mod p
where Eₖ is a commutative encryption function that operates in a group G, k is the unique key k_{ed1} associated with the first module, ID is an identity attribute, H is a cryptographic hash function that produces a random group element and p is (2q+1) where q is a prime number.

10. The system according to claim 9 wherein the decryption function D( ) is defined as the inverse of encryption function E( ) and the unique key k_{dd1} comprises an inverse of the unique key k_{ed1}.

11. The system according to claim 7 wherein the untrusted server is configured to:
further compute a zero-knowledge proof of correctness based on the encrypted identity attributes in the obfuscated dataset and the further encrypted identity attributes, and
forward the zero-knowledge proof of correctness to the integration module, whereby the integration module is configured to decrypt part of the encrypted identity attributes using the unique key k_{dd1} and a decryption function D( ) if the received zero-knowledge proof of correctness matches with a zero-knowledge proof of correctness computed by the integration module.

12. The system according to claim 7 wherein the first module is further configured to encrypt non-identity type attributes of the first module's dataset using deterministic Advanced Encryption Standards.
